(19) United States
(12) Patent Application Publication
(10) Pub. No.: US 2004/0129369 A1
(43) Pub. Date: Jul. 8, 2004

(54) Sleeved articles and process for making

(75) Inventors: David E. Johnson, Dawsonville, GA (US); Clarence B. Jacobs, Alpharetta, GA (US)

Correspondence Address: KENNETH S WATKINS JR, 372 RIVER DR, DAHLONEGA, GA, 30533, US

(73) Assignee: Easy Contract Labeling, Inc.

(21) Appl. No.: 10/739,622

(22) Filed: Dec. 18, 2003

Related U.S. Application Data
(60) Provisional application No. 60/435,852, filed on Dec. 21, 2002.

(51) Int. Cl. B29C 61/02; B29C 63/42; B32B 31/00

(52) U.S. Cl. 156/85; 428/35.1; 264/230

(57) ABSTRACT

A process for installing a shrink sleeve [101] on an asymmetric article [103] comprises placing the shrink sleeve over the article and supporting the sleeved article in an orientation so that the portion of film [321] which will result in the greatest shrinkage is in the lowest vertical position and the longitudinal axis of the article forms an angle of less than 90 degrees with the horizontal. The process reduces wrinkling of high-shrinkage areas of asymmetrical articles such as liquid containers with pour spouts.

This application claims the priority of U.S. Provisional Application 60/435,852 filed Dec. 21, 2002.

### FIELD OF THE INVENTION

The present invention relates to shrink sleeves for heat shrinking onto articles and, more particularly, to a process for shrinking sleeves on asymmetric or highly contoured articles.

### BACKGROUND OF THE INVENTION

Shrink sleeves have proven useful for packaging, displaying and labeling articles such as liquid and powder containers, toys, appliances and tools. Shrink sleeves offer a low cost means of protecting articles and providing security by incorporation of tamper-resistant features. Preprinted sleeves offer a low cost means to improve marketability through improved appearance, and provide necessary product information to the consumer.

Shrink sleeves are typically made from seamed or seamless tubes. When high quality graphics are desired, shrink film is normally pre-printed to allow full front, back and side graphics. After printing, a welded or solvent-sealed seam provides a longitudinal seam, forming the sleeve.

Traditional shrink sleeves are rectangular in the lay flat condition and provide the best results with cylindrical or other solid shapes with relatively constant perimeter or outer circumference as a function of article height. This is especially important with printed graphics such as text or images, since non-uniform shrinkage occurs when shrunk over the article causes distortion of the graphics. Some distortion is normally acceptable and can be compensated for in the printing process. In some articles, such as highly contoured or asymmetric containers or bottles with pour spouts, the resulting differences in the transverse circumference of the article along the height or length of the sleeve results in wrinkling and excessive printing distortion, especially in the highly contoured portions. Even on non-printed sleeves, highly contoured articles requiring high shrink ratio films will result in poor visual qualities of the article, and high sleeve stress concentrations in the highly contoured portions of the article.

Shrink sleeves may be contoured to overcome the problems associated with highly contoured articles. U.S. application Ser. No. 10/015,062, hereby incorporated by reference, addresses the use of contoured shrink sleeves. A method which provides improved visual qualities utilizing conventional non-contoured sleeves is needed.

### OBJECTS AND SUMMARY OF THE INVENTION

Therefore, an object of the present invention is to provide a method of installing conventional shrink sleeves for use with asymmetric and highly contoured articles that provides improved visual qualities as compared with current methods.

Another object of the present invention is to provide a sleeved article having high quality sleeve graphics in highly contoured portions of the article.

Yet another object of the present invention is to provide apparatus and methods for installing shrink sleeves on asymmetric and highly contoured articles which have not been previously practical.

For purposes of this disclosure, a shrink sleeve is defined as a generally tubular structure defining a longitudinal direction along the axis of the tube and a transverse direction perpendicular to the longitudinal direction. The transverse direction defines a width direction of the lay-flat sleeve and any direction perpendicular to the longitudinal direction of an opened sleeve. The shrink sleeves are made of a heat shrinkable film and having an open top and an open bottom. A centric axis of the sleeve is a longitudinal axis passing through the geometric center (or center of area) of a transverse cross section of the opened tube. The shrink sleeve of the preferred embodiment has a rectangular lay-flat shape.

For the purposes of this disclosure, a centric axis of a sleeve is defined as an axis perpendicular to a transverse plane of the sleeve passing through the geometric center or center of area cut by the outside surface of the sleeve. The centric axis of a sleeve placed over most articles such as containers is generally uniform since the unshrunk sleeve will assume a generally uniform transverse cross section along the length of the sleeve. The centric axis of an article to be sleeved is uniform only if all transverse planes of the article are symmetric about a common centric axis. An asymmetric article will define more than one centric axis (centric axes of various transverse plane displaced from each other), depending on the longitudinal position of the plane.

For the purposes of this disclosure, a preferentially orientated film is defined as a film having the greatest shrinkage in a defined direction, normally the transverse direction in a finished shrink sleeve and perpendicular to the longitudinal direction of the sleeve.

For the purposes of this disclosure, shrink ratio is defined as the original length of a non-shrunk portion of heat shrinkable film in the defined direction divided by the free-shrunk length of the film in the defined direction after subjected to a shrinkage treatment such as a heat treatment.

For the purposes of this disclosure, an asymmetrical article is defined as an article having more than one centric axis about all possible transverse planes cut by the outside surface of the article (perpendicular to a longitudinal axis of the article).

The shrink sleeve of the present invention is made of a preferentially orientated heat shrink film and has a uniform lay flat-width (or uniform transverse circumference). A contoured article for applying the shrink sleeve has a non-uniform transverse circumference over the length or longitudinal (sleeve) axis of the article. The shrink ratio of the film may be selected to be as low as the ratio of the maximum transverse circumference of the contoured article to the minimum transverse circumference of the contoured article at the desired location of placement on the article. In the preferred embodiments, the shrink ratio is selected to be greater than the largest ratio of the transverse circumference of the article to the minimum transverse circumference of the contoured article over the desired location of placement on the article.

The process of the present invention provides an orientation of the sleeved article before shrinking which is determined by the shape of the sleeved article. In a preferred embodiment of the invention, wrinkling is minimized by orientating or rotating the article so that a portion of the sleeved article having the greatest distance (in a transverse direction) from the centric longitudinal axis of the sleeve to the surface of the sleeve is in a downward orientation. In this way, gravity acts to pull downward on the portion of the sleeve with greatest shrinkage to reduce wrinkles during the shrinking process. The article may be orientated so that the sleeve portion defining this distance is in the lowest position of the sleeved article.

In another embodiment of the invention, wrinkling is minimized by orientating or rotating the article, so that an edge (or longitudinal line) portion of the article having the largest difference between distances from a longitudinal axis of the article to the edge (or line portion) over the length of the sleeve.

The contoured shrink sleeve is especially useful on asymmetric packages such as containers having pour spouts. These articles normally have large differences in the transverse circumference of the pour area of the container as compared to the lower body of the container and the pour spouts are often offset with respect to rest of the container. Shrink sleeves require relatively large shrink ratios in the transverse direction in order to maintain a tight fit of the sleeve after shrinking. Large shrink ratio film is more costly, and often results in wrinkles and distorted printing in the necked down or pour spout area.

In the preferred embodiments, the shrink film is pre-printed in any desired location, including the lowest circumference portions of the contoured article. In conventional, rectangular lay flat sleeves, minimum circumference portions of the article correspond to large shrinkage portions, resulting in severe deformation of graphics printed on the sleeve.

### BRIEF DESCRIPTION OF THE DRAWINGS

These and other features, aspects and advantages of the present invention will become better understood with regard to the following description, appended claims and accompanying drawings where:

FIG. 1 is a perspective drawing of a heat shrink sleeve and an asymmetric article for use with the sleeve;

FIG. 2 is a perspective drawing of the asymmetric article of FIG. 1 with the sleeve installed over the article;

FIG. 3 is a perspective drawing of the sleeved article of FIG. 1 supported in a position of the present invention by a support attached to a conveyor for transferring the sleeved article in a shrink oven;

FIG. 4 is a perspective drawing of the sleeve of the sleeved article of FIG. 3 shrunk over the article;

FIG. 5 is a perspective drawing of a sleeved article support assembly engageable with a conveyor for supporting the sleeved article through a shrink oven; and

FIG. 6 is a side elevation drawing of a sleeved container having the spout portion with the largest shrink portion of the sleeve rotated to a vertical downward position.

### DESCRIPTION OF THE PREFERRED EMBODIMENTS

The following is a description of the preferred embodiments of a shrink sleeve for asymmetric articles or products.

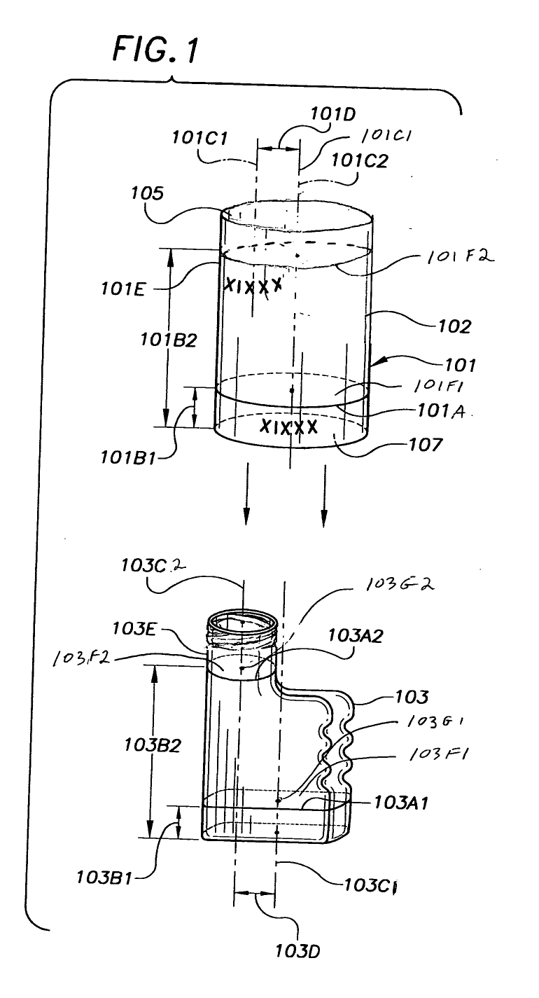

FIG. 1A is a perspective drawing of a shrink sleeve 101 of the present invention for use with a highly-contoured, asymmetric article such as pour container 103. Container 103 comprises a variable outer transverse circumference 103A1, 103A2 as a function of height 103B1, 103B2.

In one aspect of the invention, container 103 is asymmetric resulting in an upper centric vertical axis 103C2 in the spout area of the container transversely displaced by distance 103D from a centric lower vertical axis 103C1 in the body of the container. Axes 103C1 and 103C2 are perpendicular to the respective transverse or horizontal planes 103F1 and 103F2 through the geometric centers 103G1 and 103G2 of the plane surfaces enclosed by the container. Geometric centers 103G1 and 103G2 may also be referred to the center of gravity or center of area of the respective planes bounded by the outside surface of the container.

Sleeve 101 is normally symmetric, having a centric upper longitudinal or vertical axis 101C1 of horizontal planar surface 101F2 coincident with centric lower vertical axis 101C2 of horizontal planar surface 101A2. In the preferred embodiment of the present invention, sleeve 101 is rectangular when in a lay-flat condition and a right circular (or uniformly “flattened”) cylinder when open as shown in the figure and comprises an open top 105 and an open bottom 107. The circumference, or alternatively, the lay flat width of sleeve 101 is constant with the longitudinal or height direction.

In the more general form, axes 101C1, 101C2, of sleeve 101 and axes 103C1 and 103C are longitudinal axes of the sleeve and article respectively, and the respective planes 101F1, 101F2, 103F1 and 103F2 are transverse planes bounded by the outside surfaces of the sleeve and article respectively.

In the preferred embodiments, circumference 101A of sleeve 101 is slightly greater than the largest circumference 103A1 of article 103. The greater circumference 101A, as compared to corresponding circumferences 103A1, allows sleeve 101 to be easily positioned in the desired area of application over container 103 by manual or automated means as shown in FIG. 1B. In other embodiments, circumference 101A is less than, or equal to, circumference 103A1, requiring a stretch installation on container 103.

Surprisingly, it has been found that reduced wrinkling during shrinking is achieved by specific orientation of the sleeved article with respect to the direction of gravity during the heat shrinking process.

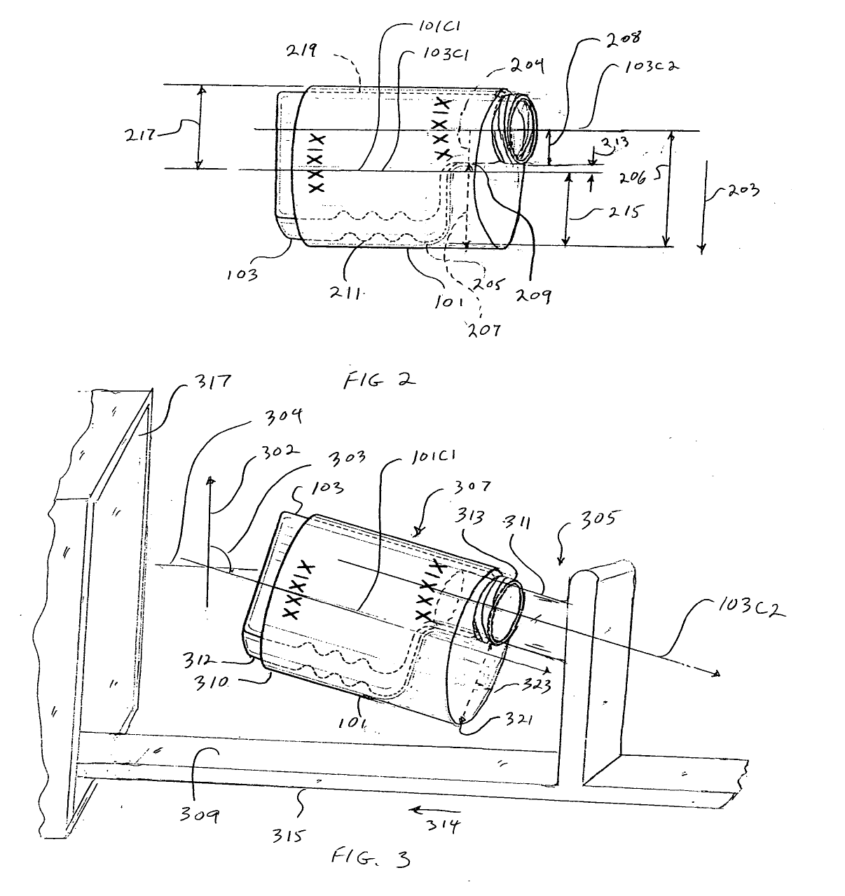

FIG. 2 is a perspective drawing of sleeve 101 inserted over container 103 with the longitudinal axis 101 Cl of sleeve 101 generally parallel to the longitudinal axes of container 103. Axis 101C2 is omitted for clarity. Longitudinal axis 103C1 of container 103 is generally coincident with axis 101C1 of sleeve 101, and shown horizontal with respect to the direction of gravity 203. It has been found that wrinkling is reduced when a radial direction from a longitudinal axis having the greatest difference of distance from any two surface portions of the article covered or overlapped by the sleeve and in the same radial direction is orientated generally downward in the direction of gravity. For example, the radial direction 204 defining maximum difference distance 207 between longitudinal axis 103C2 and portions 205 (distance 206) and 209 (distance 208) of container 103 is placed in a downward direction with respect to gravity.

In another embodiment, wrinkling is reduced when a longitudinal or edge portion of the article having the greatest difference between minimum and maximum transverse distance from a longitudinal axis of the article is in a downward direction with respect to gravity. For example, the algebraic difference of distances 213 and 215 for edge surface 211 from longitudinal axis 103C1 represents a maximum difference and is placed in a downward position. The difference between the distance between any two points along edge 219 (distance 217) represents a zero (minimum) difference from centric axis 103C1 and would be place in an upward (opposite from the direction of gravity) orientation.

FIG. 3 is a perspective drawing of a sleeved article being transported into a shrink oven 317 by a conveyor 315. In practice, the longitudinal axis 101C1, of container 103 is rotated at an angle 303 with respect to vertical axis 302 to achieve the effect of reduced wrinkling. Longitudinal axis 101C1 is taken in the direction of the portion of greatest shrinkage such as the pour spout direction (indicated by the arrow of axis 101C1). In the preferred embodiments, angle 303 is greater than 30 degrees. In the more preferred embodiments, angle 303 is greater than 60 degrees. In the still more preferred embodiments, angle 303 is greater than 90 degrees, wherein axis 101C1 is rotated below the horizontal direction 304. Likewise, longitudinal axis 103C2 of container 103, taken in the direction outward from spout 313 makes an angle of greater than 90 degrees with vertical 302, depressing axis 103C2 below horizontal 304.

In one aspect of the invention, a suspension means such as support 305 of FIG. 3 supports sleeved container 307 with axes 101C1, 103C2 at the desired angle with respect to the vertical and with no contact between sleeve 101 and a support surface such as surface 309. In the embodiment shown, support member 311 of support 305 engages pour spout 313 of container 103. Although support 305 is shown engaging the internal portion of pour spout 313, different supports engaging any portion of the top or bottom (either end) of container 103 is satisfactory as long as contact with sleeve 101 is avoided. In this embodiment, support 305 is attached to a conveyor portion 315 conveying support 305 and sleeved container 307 into a shrink oven 317 for shrinking.

In general, greatest stability with least wrinkling is obtained with the sleeve portion 310 having the least shrinkage (such as over the bottom portion 312 of container 103) entering the oven first, as shown by arrow 314. Shrinking the portion with the least shrinkage anchors the sleeve to the article in the desired location before the high-shrinkage portion introduces distorting forces on the sleeve.

In another application of the method, sleeved article 307 is orientated so that the sleeve portion 321 which will result in the greatest shrinkage when heated is in the lowest vertical position. This portion may be defined as the sleeve portion having the longest distance (323) to the nearest outside surface of the article in the same transverse plane. Shrink oven 317 of FIG. 3 may be a conventional oven used for shrinking sleeves, or it may utilize additional heat elements positioned to provide directed heat to specific areas of sleeved container 307 during the motion or travel of sleeved container 307 through the apparatus.

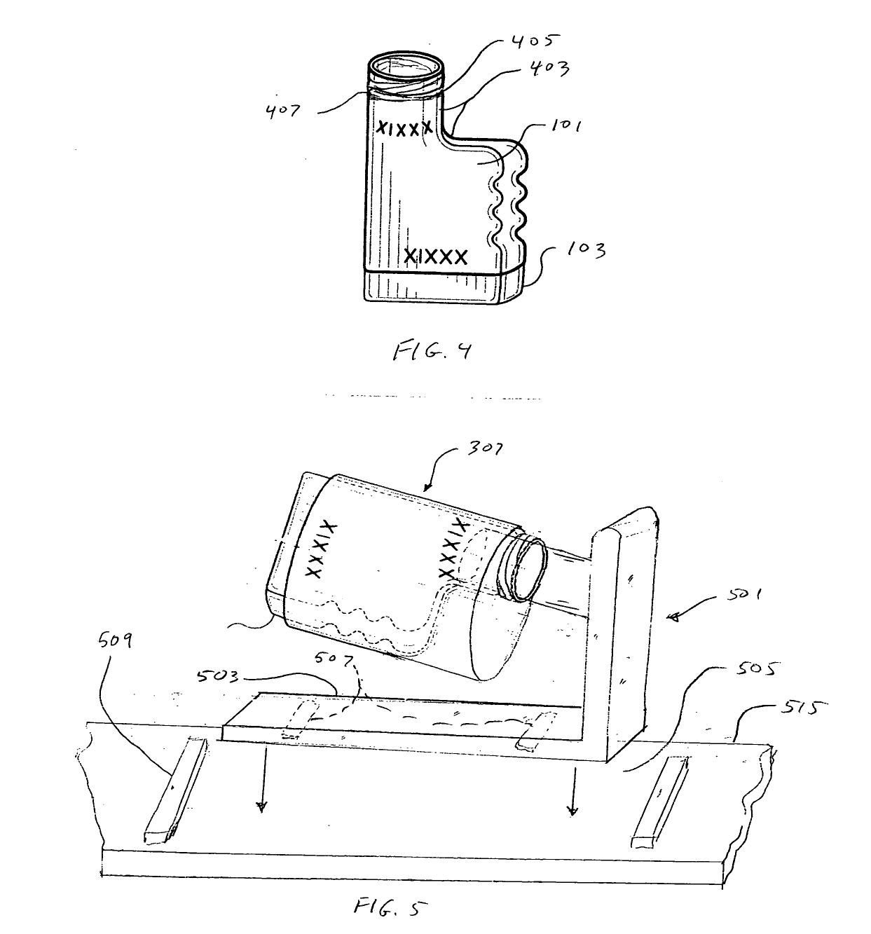

FIG. 4 is a perspective drawing of container sleeve 101 shrunk on container 103. Wrinkling, especially in the portion of highest shrinkage 403 is reduced as compared to conventionally shrunk sleeve processes. Distortion of shrink sleeve ends, such as canting of the upper end of sleeve 101 at 405 can be compensated for by trimming sleeve 101 before shrinking, or by compensation in the printing of graphics. For example, providing a clear wedge-shaped portion 407 in the pour spout area restores the appearance of a canted end portion of the sleeve.

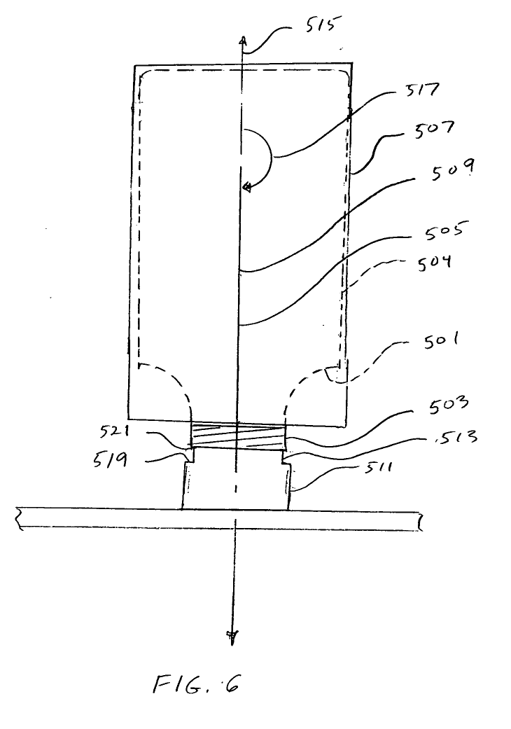

FIG. 5 is a perspective drawing of a removable support apparatus 501 for supporting a sleeved container 307 for setting on or otherwise engaging a conveyor 515 prior to the shrinking process. Support apparatus 501 is similar to support 305 of FIG. 3 except that the support apparatus 501 includes a base 503 for setting on the upper surface 505 of conveyor 515. Base 503 may utilize engagement elements such as strips 507 on the bottom of base 503 to further secure support apparatus 501 to conveyor 515 and may include adhesive strips, magnetic strips, hook and loop fasteners, or other mechanical fasteners known in the art. Engagement elements on the conveyor such as support bars 509 may also be used to further engage support assembly 501 to conveyor 515. Support apparatus 501 may be constructed of plastic, metal, wood or ceramics. Other embodiments of the support apparatus engage container 103 from either or both ends.

FIG. 6 is a side elevation drawing of an embodiment of the present invention used on highly contoured symmetric article such as a container 501 with spout 503. Axis 505 is a longitudinal axis about the body 504 and spout area of the container and is directed toward the spout from the body or geometric center of the article as shown by the arrow of axis 505. A centric axis 509 of sleeve 507 is coincident with axis 505. Article support 511 comprises a spout engagement element such as dowel 513 to support container 501 in a downward direction with axis 505 rotated 180 degrees from vertical 515 as indicated by arrow 517. Shoulder 519 provides a stop to prevent for lip 521 of container 501.

In the preferred embodiments of the invention, the sleeves are made of preferentially-orientated film. The film may be polyvinyl chloride (PVC), polyethylene (PE), polypropylene (PP), other polyolefins and copolymers, polyesters (PETG, OPETE) and polystyrene (OPS). In the preferred embodiments, the major shrink axis is transverse to the longitudinal axis of the sleeve.

In the preferred embodiments, orientated films having shrink ratios greater than 1.25 in the transverse direction are used. In the still more preferred embodiments, orientated films having shrink ratios of greater than 1.5 are used. In the most preferred embodiments, orientated films having shrink ratios of less than 2.0 are used. In other embodiments, films may be non-orientated.

Accordingly, the reader will see that the shrink sleeve method of the present invention provides improved-appearance shrink sleeves for contoured articles, especially asymmetric articles such as containers with pour spouts.

Although the description above contains many specifications, these should not be construed as limiting the scope of the invention but merely providing illustrations of some of the presently preferred embodiments of this invention. Thus the scope of the invention should be determined by the appended claims and their legal equivalents, rather than by the examples given.

We claim:

1. A process for shrinking a sleeve on an asymmetric article, the process comprising the steps:
positioning a shrink sleeve around said article to form a pre-shrunk sleeved article wherein a longitudinal axis of said sleeve is generally aligned with a longitudinal axis of said article;
positioning said pre-shrunk sleeved article in a predetermined position wherein wrinkling of said sleeve is minimized during shrinking, said predetermined position comprising said longitudinal axis of said article having an orientation of less than ninety degrees with a horizontal direction; and
heating said sleeve to shrink said sleeve on said article.

2. The process of claim 1 wherein said predetermined position comprises orientating a radial direction from a second longitudinal axis of said article having a greatest difference of distance from two surface portions overlapped by said sleeve of said article downward in the direction of gravity.

3. The process of claim 1 wherein said predetermined position comprises orientating an edge portion of said article having a greatest algebraic difference between a minimum and a maximum transverse distance from a second longitudinal axis of said article over a sleeved length of said article is in a downward direction with respect to gravity.

4. The process of claim 1 wherein said predetermined position comprises orientating said pre-shrunk sleeved article so that a sleeve portion which will result in a greatest shrinkage when heated is in a lowest vertical position.

5. The process of claim 4 wherein said sleeve portion comprises a greatest distance to a nearest outside surface of said article in a same transverse plane.

6. The process of claim 2 wherein said article is a container and said second longitudinal axis of said article is a centric axis of an opening of said container.

7. The process of claim 2 wherein said article is a container and said second longitudinal axis of said article is a centric axis of a body portion of said container.

8. The process of claim 3 wherein said article is a container and said second longitudinal axis of said article is a centric axis of an opening of said container.

9. The process of claim 3 wherein said article is a container and said second longitudinal axis of said article is a centric axis of a body portion of said container.

10. A sleeved article made from a process comprising the steps:
positioning a shrink sleeve around said article to form a pre-shrunk sleeved article wherein a longitudinal axis of said sleeve is generally aligned with a longitudinal axis of said article;
positioning said pre-shrunk sleeved article in a predetermined position wherein wrinkling of said sleeve is minimized during shrinking, said predetermined position comprising said longitudinal axis of said article having an orientation of less than ninety degrees with a horizontal direction; and
heating said sleeve to shrink said sleeve on said article.

11. The article of claim 10 wherein said predetermined position comprises orientating a radial direction from a second longitudinal axis of said article having a greatest difference of distance from two surface portions overlapped by said sleeve of said article downward in the direction of gravity.

12. The article of claim 10 wherein said predetermined position comprises orientating an edge portion of said article having a greatest algebraic difference between a minimum and a maximum transverse distance from a second longitudinal axis of said article over a sleeved length of said article is in a downward direction with respect to gravity.

13. The article of claim 10 wherein said predetermined position comprises orientating said pre-shrunk sleeved article so that a sleeve portion which will result in a greatest shrinkage when heated is in a lowest vertical position.

14. The article of claim 13 wherein said sleeve portion comprises a greatest distance to a nearest outside surface of said article in a same transverse plane.

15. A support apparatus for a pre-shrunk sleeved article comprising a shrink sleeve axis, said support axis comprising:
an article support portion connected to the base portion, the article support portion comprising an engagement element engageable to a portion of said pre-shrunk sleeved article so that said shrink sleeve axis defines an axis with and angle to a vertical of less than 90 degrees.

16. The apparatus of claim 15 wherein said angle to a vertical is less than 60 degrees.

17. The apparatus of claim 15 wherein said angle to a vertical is less than 30 degrees.

18. The apparatus of claim 15 comprising a base portion connected to the article support portion.

19. The apparatus of claim 18 wherein said base portion comprises a flat surface portion for supporting said apparatus from a conveyor belt.

20. The apparatus of claim 15 wherein said base portion comprises an engagement element for fixing said apparatus to a conveyor belt.

21. 1. A process for shrinking a sleeve on an a container comprising a body portion and a spout portion, the process comprising the steps:
positioning a shrink sleeve around said container to form a pre-shrunk sleeved article wherein a longitudinal axis of said sleeve is generally aligned with a first longitudinal axis of said container and said spout portion defining a second longitudinal axis with a direction away from said body portion;
positioning said pre-shrunk sleeved article in a predetermined position wherein wrinkling of said sleeve is minimized during shrinking, said predetermined position comprising said second longitudinal axis of said container being rotated at an angle greater than 90 degrees from a vertical direction; and
heating said sleeve to shrink said sleeve on said article.

22. The process of claim 21 wherein said container is an asymmetric article and said second longitudinal axis is orientated below a centric axis of said body portion.

23. The process of claim 21 wherein said second longitudinal axis is rotated substantially 180 degrees.
